(19) United States
(12) Patent Application Publication
(10) Pub. No.: US 2009/0044667 A1
(43) Pub. Date: Feb. 19, 2009

(54) Swivel adaptor

(75) Inventor: Glenn A. Kaufman, Kenosha, WI (US)

Correspondence Address: SEYFARTH SHAW LLP, 131 S. DEARBORN ST., SUITE 2400, CHICAGO, IL, 60603-5803, US

(73) Assignee: Snap-on Incorporated

(21) Appl. No.: 11/893,178

(22) Filed: Aug. 15, 2007

(51) Int. Cl. B25B 13/06

(52) U.S. Cl. 81/124.5; 81/450

(57) ABSTRACT

A swivel adapter comprising a first member having a longitudinal axis, a first recess at one end thereof and an outer surface, first and second apertures disposed at diametrically opposing locations on the first member and communicating with the first recess, a second member having a proximal end disposed within the first recess and a distal end, a first bore disposed substantially adjacent to the proximal end that extends transversely through the second member and is substantially coaxial with the first and second aperture, a pin having first and second ends axially disposed in the first aperture, second aperture and first bore, wherein the first and second members are adapted to pivot relative to each other about the pin, and a first weld fixedly attaching the first end of the pin to the outer surface of the first member adjacent to the first aperture.

### BACKGROUND OF THE INVENTION

The present invention relates generally to a swivel adaptor for a fastener driving tool, and more particularly, to a swivel adaptor used to connect the drive shaft of a fastener driving tool to a socket head.

It is common to use a swivel adaptor to connect a fastener driving tool to a socket head when it is desirable to drive a fastener from various angles. For example, one may use a swivel adaptor to connect an impact driver, such as a pneumatic wrench, to a socket head. However, when driven by a high powered fastener driving tool such as a pneumatic driver, a swivel adaptor may be subjected to torque exceeding 300 lb-ft over repeated impacts. As such, the high forces and repetitive impacts have caused prior art swivel adaptors to fracture and prematurely fail.

A well known prior art swivel adapter comprises a housing, ball and pin. A pin is used to couple the ball to the housing by passing freely though a bore, which extends transversely through the housing. A collar keeps the pin from axially sliding relative to the bore and disengaging from the housing. When in use, such swivel adapters permit the pin to apply force to the collar. High forces applied by the pin and ball have caused the collar to loosen, wear thin or fracture, thus causing premature failure of the swivel adapter. Failures have also occurred at the pin itself. As such, it is desirable to have a more durable swivel adaptor capable of withstanding the high torque and repeated impacts applied by pneumatic drivers or the like.

### BRIEF SUMMARY OF THE INVENTION

An embodiment of the present invention includes a first member having a longitudinal axis, a first recess at one end, a drive recess at the other end and an outer surface. First and second apertures are disposed at diametrically opposing locations on the first member and communicate with the first recess. A second member has a proximal end disposed within the first recess and a distal end. A first bore is disposed substantially adjacent to the proximal end and extends transversely through the second member and is substantially coaxial with the first and second apertures. A pin having first and second ends is axially disposed in the first aperture, second aperture and first bore, whereby the first and second members are permitted to pivot relative to each other about the pin. A first weld is used to fixedly attach the first end of the pin to an outer surface of the first member adjacent to the first aperture to prevent axial movement thereof. A bias member is disposed within the first recess. The bias member is adapted to urge the second member to a position that is substantially upright relative the longitudinal axis.

### BRIEF DESCRIPTION OF THE DRAWINGS

For the purpose of facilitating an understanding of the subject matter sought to be protected, there is illustrated in the accompanying drawings embodiments thereof, from an inspection of which, when considered in connection with the following description, the subject matter sought to be protected, its construction and operation, and many of its advantages, should be readily understood and appreciated.

FIG. 1 is a perspective view of an embodiment of the swivel adaptor of the present application in an assembled state showing the second member in the upright position.

FIG. 2 is an enlarged partial cross-sectional view of an embodiment of the swivel adaptor of FIG. 1, but showing the second member in a swiveled position.

FIG. 3 is an exploded isometric view of an embodiment of the swivel adaptor of FIG. 1.

### DETAILED DESCRIPTION OF THE PREFERRED EMBODIMENT

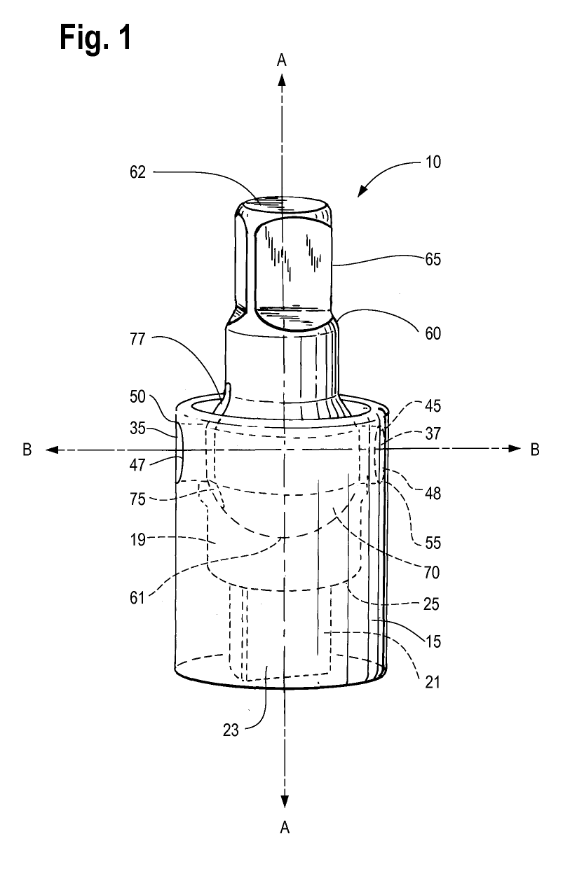

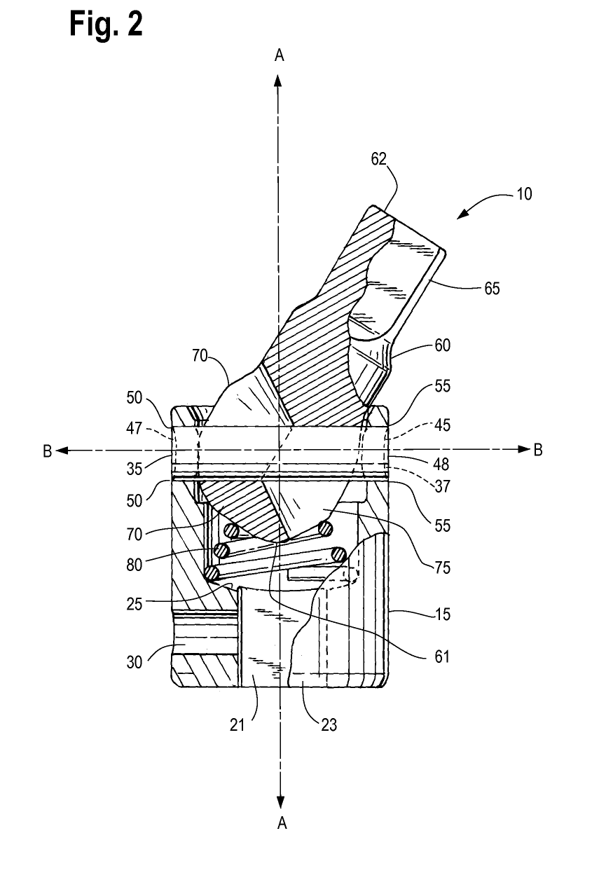

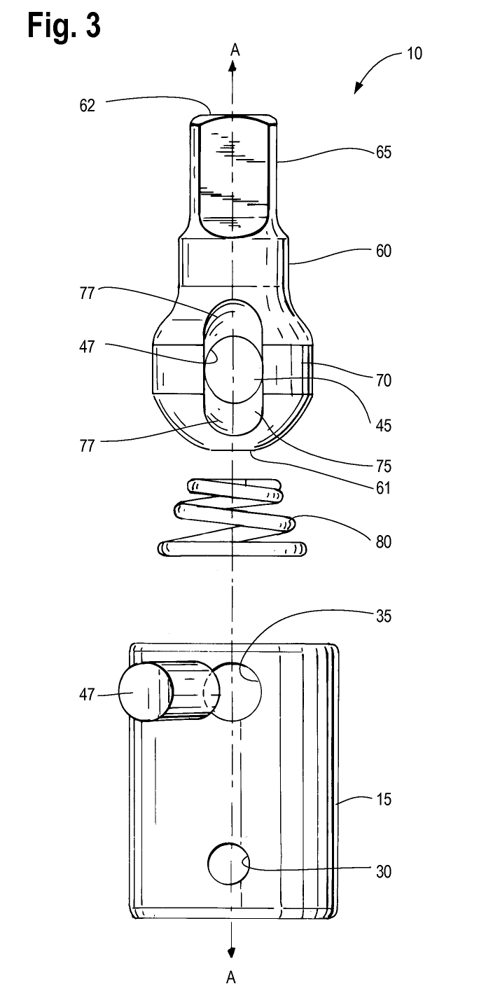

Referring to FIGS. 1-3, an embodiment of the swivel adaptor of the present application generally referred to as numeral 10 is shown. The embodiment includes a first member 15 having a longitudinal axis A-A. In an embodiment, the first member 15 is cylindrical. The first member 15 has a first recess 19, which substantially resembles a hollow cylinder, and a drive recess 21. The drive recess 21 includes a passage 23 at one end and a ledge 25 at the other end. The passage 23 is adapted to be engaged by a drive shaft of a fastener driving tool such as a pneumatic wrench or the like (not shown). It will be appreciated that the drive recess 21 need not be limited to having a square cross section such as that shown in FIGS. 1 and 2. Instead, the drive recess need only conform with the shape of the drive shaft of the fastener driving tool. The passage 23 may include a bore 30 (shown in FIGS. 2, 3) adapted to engage a detent (not shown) in a well known manner. First and second apertures 35, 37 are disposed at diametrically opposing locations on the first member 15 and are in communication with the first recess 19.

A second member 60 having proximal and distal ends 61, 62 has a drive shaft 65 at the distal end 62, preferably in the form of a square shaft as shown in FIG. 1, whereby the drive shaft 65 is adapted to engage a socket head (not shown) in a well known manner. It will be appreciated that while the drive shaft 65 is depicted as a square shaft for fitment with a socket head, the drive shaft 65 can be shaped to engage any well-known tool head, such as, for example, a phillips screw driver head. The second member 60 may have a ball 70 at the proximal end 61 disposed inside the first recess 19 and a first bore 75 disposed substantially adjacent to the proximal end 61 that extends transversely through the second member 60. The ball 70 and the first recess 19 cooperatively form a ball-joint The first bore 75 is substantially coaxial with the first and second apertures 35, 37 and may have flared, beveled or oblongly shaped ends 77, as shown in FIGS. 1 and 3.

A pin 45 having a horizontal axis B-B and first and second ends 47, 48 is disposed axially through the first aperture 35, second aperture 37 and first bore 75. The pin 45 may have a circular cross section and first and second ends 47, 48 respectively adjacent to the first and second apertures 35, 37. The pin 45 may have a diameter of, at least, 0.290 inches and preferably 0.293 inches. The first member 15 includes a means for fixedly attaching the first and second ends 47, 48 to the outside surface of the first member 15. The means may include applying first and/or second welds 50, 55 respectively to the first and second ends 47, 48 adjacent to the first and second apertures 35, 37. The first and second welds 50, 55 are preferably formed by a laser welding process, but it will be appreciated that other welding means may be used.

The pin 45 rotatably engages the first bore 75, whereby the second member 60 is permitted to pivot between a substantially upright position, shown in FIGS. 1 and 3, where the second member 60 is disposed substantially axial relative to the longitudinal axis A-A, and a tilted position, shown in FIG. 2, where the second member 60 is tilted relative to the longitudinal axis A-A. It will be appreciated that the flared ends 77 permit the second member to swivel in multiple directions about multiple axis.

A bias member 80 in the form of a coil spring or the like abuts ledge 25 and acts against the proximal end 61. It will be appreciated that as the second member 60 approaches the tilted position, the force applied by the bias member 80 increases, thereby urging the second member 60 toward the upright position as shown in FIG. 2.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicant's contribution. The actual scope of the protection sought is intended to be defined in the following claims when viewed in their proper perspective based on the prior art.

1. A swivel adaptor for a fastener driving tool comprising:
a first member having a longitudinal axis, a first recess at one end thereof, a drive recess at an opposite end and an outer surface;
first and second apertures disposed at diametrically opposing locations on the first member and communicating with the first recess;
a second member having a proximal end disposed within the first recess, a distal end and a drive shaft located at the distal end;
a first bore disposed substantially adjacent to the proximal end that extends transversely through the second member and is substantially coaxial with the first and second apertures;
a pin having first and second ends axially disposed in the first aperture, the second aperture and the first bore, wherein the first and second members are adapted to pivot relative to each other about the pin; and
a first weld fixedly attaching the first end of the pin to the outer surface of the first member adjacent to the first aperture.

2. (canceled)

3. The swivel adapter of claim 2 wherein the second member has a bail at the proximal end and the ball and the first recess cooperatively form a ball-joint.

4. The swivel adapter of claim 3 further comprising a bias member disposed within the first recess adapted to urge the second member to a position tat is substantially upright relative the longitudinal axis.

5. The swivel adapter of claim 4 wherein the first bore includes flared edges.

6. The swivel adapter of claim 1 further comprising a second weld fixedly attaching the second end of the pin to the outer surface of the first member adjacent to the second aperture.

7. The swivel adapter of claim 6 wherein the first and second welds are formed by a laser welding process.

8. A swivel adaptor for a fastener driving tool comprising:
a first member having a longitudinal axis, a first recess at one end thereof, a drive recess at the other end thereof and an outer surface;
first and second apertures disposed at diametrically opposing locations on the first member and communicating with the first recess;
a second member having a proximal end disposed within the first recess;
a first bore disposed substantially adjacent to the proximal end that extends transversely through the second member and is substantially coaxial with the first and second apertures;
a pin having first and second ends axially disposed in the first aperture, the second aperture and the first bore, wherein the first and second members are adapted to pivot relative to each other about the pin;
a first weld fixedly attaching the first end of the pin to the outer surface of the first member adjacent to the first aperture; and
a bias member disposed within the first recess adapted to urge the second member to a position that is substantially upright relative the longitudinal axis.

9. The swivel adapter of claim 8 further comprising a second weld fixedly attaching the second end of the pin to the outside surface of the first member adjacent to the second aperture.

10. The swivel adapter of claim 9 wherein the first and second welds are formed by a laser welding process.

11. A swivel adaptor for a fastener driving tool comprising:
a first member having a first longitudinal axis, a first recess at one end thereof, a drive recess at an opposite end and an outer surface;
first and second apertures disposed at diametrically opposing locations on the first member and communicating with the first recess;
a second member having a proximal end disposed within the first recess, a distal end and a drive shaft located at the distal end;
a first bore disposed substantially adjacent to the proximal end that extends transversely through the second member and is substantially coaxial with the first and second apertures;
a pin having first and second ends axially disposed in the first aperture, second aperture and first bore; and
a means for coupling the pin to the first recess.

12. The swivel adaptor of claim 11 wherein the means for coupling includes a first weld fixedly attaching the first end of the pin to the outer surface adjacent to the first aperture.
